(19) United States
(12) Patent Application Publication
(10) Pub. No.: US 2012/0171024 A1
(43) Pub. Date: Jul. 5, 2012

(54) BEARING HOLDING STRUCTURE AND FAN MODULE USING SAME

(75) Inventor: Wen-Hao Liu, Sinjhuang City (TW)

(73) Assignee: ASIA VITAL COMPONENTS CO., LTD., Sinjhuang City (TW)

(21) Appl. No.: 12/983,323

(22) Filed: Jan. 2, 2011

(51) Int. Cl. F01D 25/16; F16C 27/06

(52) U.S. Cl. 415/174.2; 384/215

(57) ABSTRACT

A fan module includes a frame; a fan wheel; and a bearing holding structure having a hollow bearing cup, an elastic member, and a bearing. The frame has a base, on a center of which the hollow bearing cup is formed. A portion of an inner wall surface of the hollow bearing cup is radially inward protruded, forming a shoulder portion between the inner wall surface and the protruded portion. The elastic member includes a first and a second section tightly bearing on the shoulder portion and the inner wall surface, respectively, and the bearing is tightly supported on the elastic member. The fan wheel has a shaft extended through the bearing and is therefore rotatably mounted on the base and located in the frame. With the elastic member, the bearing is tightly received in the hollow bearing cup without colliding therewith, and stable operation of the bearing is ensured.

### FIELD OF THE INVENTION

The present invention relates to a bearing holding structure and a fan module using same; more particularly, the present invention relates to a bearing holding structure that enables a bearing to tightly receive in a hollowing bearing cup, and to a fan module using the bearing holding structure.

### BACKGROUND OF THE INVENTION

Electronic elements in an electronic product would produce heat when they operate, and are subject to burnout or damage if the produced heat is not timely removed to lower the temperature of the electronic elements. To avoid burned-out or damaged electronic elements, at least one heat dissipating unit, such as a radiating fin assembly or a heat sink, and a fan device are usually provided to remove or dissipate the heat produced by the electronic elements, so that the electronic elements can have prolonged service life.

Conventionally, to enable convenient assembling of the fan device, a bearing thereof is mounted in a bearing cup in a loose-fit manner, and a rotary shaft of a fan wheel is received in the bearing in the same loose-fit manner. When the fan device operates, the rotary shaft of the fan wheel tends to vibrate with respect to an inner side of the bearing and easily become oxidized. The oxidized rotary shaft would get stuck in the bearing and produce noise. Further, since the bearing is loosely fitted in the bearing cup to leave clearance between them, the whole fan device in operation tends to vibrate when the fan wheel rotates. These vibrating conditions result in wearing and damage of the bearing as well as shortened service life of the fan device.

To eliminate the clearance between the bearing and the bearing cup and the rotary shaft, these components must be manufactured in high precision and assembled in the tight-fit manner. These would no doubt largely increase the manufacturing cost and the assembling time of the fan device. Further, the assembling by tight fitting tends to cause damaged balls in the bearing, which in turn causes vibration and noise when the fan device operates. Therefore, the prior art fan device and the bearing thereof have the following disadvantages: (1) easy to produce vibration during operation; (2) easy to produce noise during operation; (3) leaving large clearance between the bearing and the bearing cup and the rotary shaft; and (4) shortening the service life of the bearing and the fan device.

### SUMMARY OF THE INVENTION

A primary object of the present invention is to provide a bearing holding structure and a fan module using same, so as to reduce the clearance between a bearing and a hollowing bearing cup, allowing the bearing to tightly receive in the hollowing bearing cup to operate stably.

Another object of the present invention is to provide a bearing holding structure and a fan module using same, so as to increase the service life of a bearing, and reduce the noise produced by impact of the bearing on a bearing cup during operation of the bearing.

To achieve the above and other objects, the bearing holding structure according to the present invention includes a hollow bearing cup, a first elastic member, and a first bearing. The hollow bearing cup has a first opening and an inner wall surface, and a portion of the inner wall surface located behind the first opening by a predetermined distance is radially inward protruded toward a central axis of the hollow bearing cup, so that a first shoulder portion is formed between the inner wall surface and the radially inward protruded portion to face toward the first opening. The first elastic member includes a first section tightly bearing on the first shoulder portion and a second section tightly bearing on the inner wall surface of the hollow bearing cup, and the first and the second section are connected to each other. The first bearing is received in the hollow bearing cup and disposed on the first elastic member, and the first bearing includes a first bottom tightly bearing on the first section of the first elastic member and a first side wall tightly bearing on the second section of the first elastic member.

To achieve the above and other objects, the fan module according to the present invention includes a frame, a hollow bearing cup, a first elastic member, a first bearing, and a fan wheel. The frame has a first open end; a second open end opposite to the first open end; an airflow passage communicating the first open end with the second open end; a base; and a plurality of connecting arms. The base and the connecting arms are located in the second open end, and the connecting arms are connected to between the base and a peripheral wall of the frame to thereby locate the base at a center of the second open end. The hollow bearing cup is formed on the base and has a first opening and an inner wall surface. A portion of the inner wall surface located behind the first opening by a predetermined distance is radially inward protruded toward a central axis of the hollow bearing cup, so that a first shoulder portion is formed between the inner wall surface and the radially inward protruded portion to face toward the first opening. The first elastic member includes a first section tightly bearing on the first shoulder portion and a second section tightly bearing on the inner wall surface of the hollow bearing cup; and the first and the second section are connected to each other. The first bearing is received in the hollow bearing cup and disposed on the first elastic member. The first bearing includes a first bottom tightly bearing on the first section of the first elastic member and a first side wall tightly bearing on the second section of the first elastic member. The fan wheel is mounted on the base and includes a hub, a plurality of blades, and a shaft. The blades are spaced along an outer circumferential surface of the hub to radially outward extend from the hub. The shaft has a fixed end connected to the hub and a free end extended through the first bearing into the hollow bearing cup, so that the shaft is rotatably connected to the hollow bearing cup via the first bearing.

In an operable embodiment of the present invention, the hollow bearing cup of the bearing holding structure has a closed end opposite to the first opening. In another operable embodiment of the present invention, the hollow bearing cup further has a second opening opposite to the first opening, and a second shoulder portion formed between the radially inward protruded portion and the inner wall surface of the hollow bearing cup to face toward the second opening; and the bearing holding structure further includes a second elastic member and a second bearing. The second elastic member has a third and a fourth section tightly bearing on the second shoulder portion and the inner wall surface, respectively, of the hollow bearing cup. The second bearing is received in the hollow bearing cup and disposed on the second elastic member, and includes a second bottom tightly bearing on the third section of the first elastic member and a second side wall tightly bearing on the fourth section of the second elastic member.

In the present invention, the first and the second section of the first elastic member are connected to each other at a right angle, giving the first elastic member a substantially L-shaped longitudinal cross section; similarly, the third and the fourth section of the second elastic member are connected to each other at a right angle, giving the second elastic member a substantially L-shaped longitudinal cross section.

In the present invention, the first and the second bearing respectively have a shaft hole, and are ball bearings, roller bearings, needle bearings, ceramic bearings, or oil-impregnated bearings; and the first and the second elastic member are silica-gel rings, rubber rings, or latex rings.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded sectional view of a bearing holding structure according to a first preferred embodiment of the present invention;

FIG. 2 is an assembled view of FIG. 1;

FIG. 3 is an exploded sectional view of a bearing holding structure according to a second preferred embodiment of the present invention;

FIG. 4 is an assembled view of FIG. 3;

FIG. 5 is an exploded perspective view of a fan module according to a third preferred embodiment of the present invention;

FIG. 6 is a sectional view of FIG. 5;

FIG. 7 is an assembled view of FIG. 6;

FIG. 8 is an exploded perspective view of a fan module according to a fourth preferred embodiment of the present invention;

FIG. 9 is a sectional view of FIG. 8;

FIG. 10 is an assembled view of FIG. 9;

FIG. 11 is an exploded sectional view of a bearing holding structure according to a fifth preferred embodiment of the present invention; and

FIG. 12 is an assembled view of FIG. 11.

### DETAILED DESCRIPTION OF THE PREFERRED EMBODIMENTS

The present invention relates to a bearing holding structure and a fan module using same, which will now be described with some preferred embodiments thereof. The bearing holding structure of the present invention can be applied to any mechanical structure that involves the coupling of a bearing cup with a bearing, such as a fan, a hard disk drive, a CD-ROM drive, a micro servo motor, and the like. For the purpose of easy to understand, elements that are the same in the preferred embodiments are denoted by the same reference numerals.

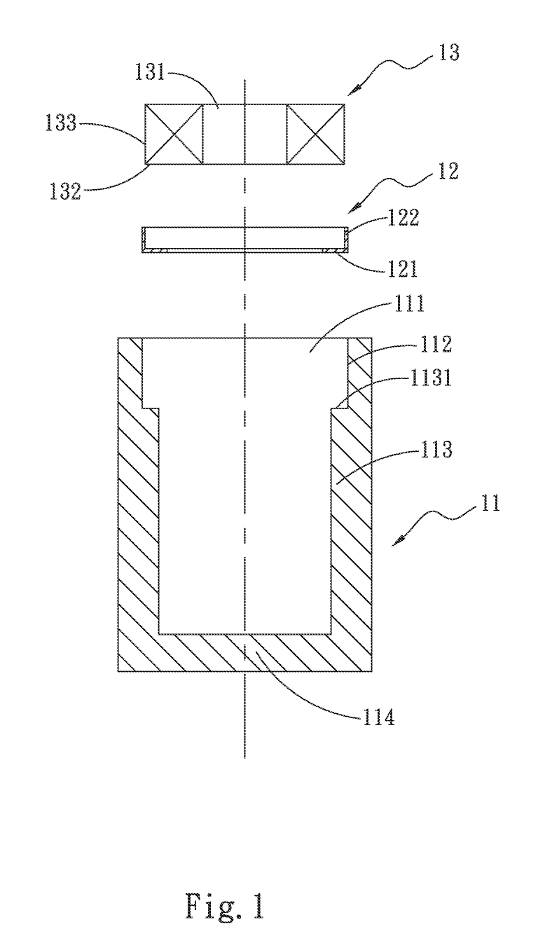

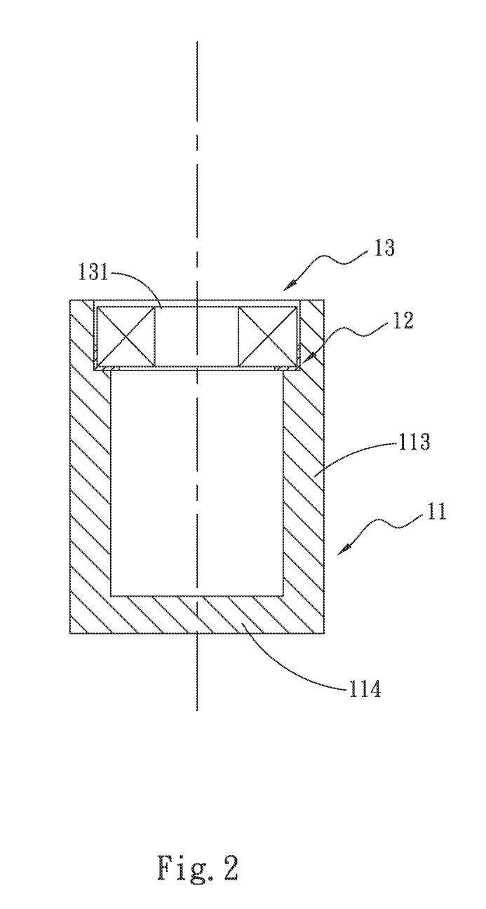

FIGS. 1 and 2 are exploded and assembled sectional views, respectively, of a bearing holding structure according to a first preferred embodiment of the present invention. As shown, the bearing holding structure includes a hollow bearing cup 11, a first elastic member 12, and a first bearing 13. The first elastic member 12 and the first bearing 13 are received in the hollow bearing cup 11.

The hollow bearing cup 11 has a first opening 111 formed at an end thereof, an inner wall surface 112, and a closed end formed at another end opposite to the first opening 111. A portion 113 of the inner wall surface 112 located behind the first opening by a predetermined distance is radially inward protruded toward a central axis of the hollow bearing cup 11, so that a first flat shoulder portion 1131 is formed between the inner wall surface 112 and the radially inward protruded portion 113 to face toward the first opening 111.

The first elastic member 12 includes a first section 121 and a second section 122 connected to each other at a right angle, so that the first elastic member 12 has a substantially L-shaped longitudinal cross section. The first section 121 of the first elastic member 12 tightly bears on the first shoulder portion 1131 and the second section 122 of the first elastic member 12 tightly bears on the inner wall surface 112 when the first elastic member 12 is disposed in the hollow bearing cup 11.

The first bearing is disposed on the first elastic member 12, and includes a first shaft hole 131, a first bottom 132, and a first side wall 133. The first bottom 132 and the first side wall 133 tightly bear on the first section 121 and the second section 122 of the first elastic member 12, respectively. That is, the first elastic member 12 fills up a clearance between the first bearing 13 and the inner wall surface 112 and the first shoulder portion 1131, and provides a supporting and buffering effect on the first bearing 13 in both axial and radial directions to prevent the first bearing 13 in operation from colliding with the hollow bearing cup 11. With these arrangements, the bearing holding structure according to the first preferred embodiment of the present invention is structurally stable and the first bearing 13 can operate stably in the hollow bearing cup 11.

In the illustrated first preferred embodiment, the axial direction indicates a direction to which the first bottom 132 of the first bearing 13 and the first section 121 of the first elastic member 12 are oriented; and the radial direction indicates a direction to which the first side wall 133 of the first bearing 13 and the second section 122 of the first elastic member 12 are oriented.

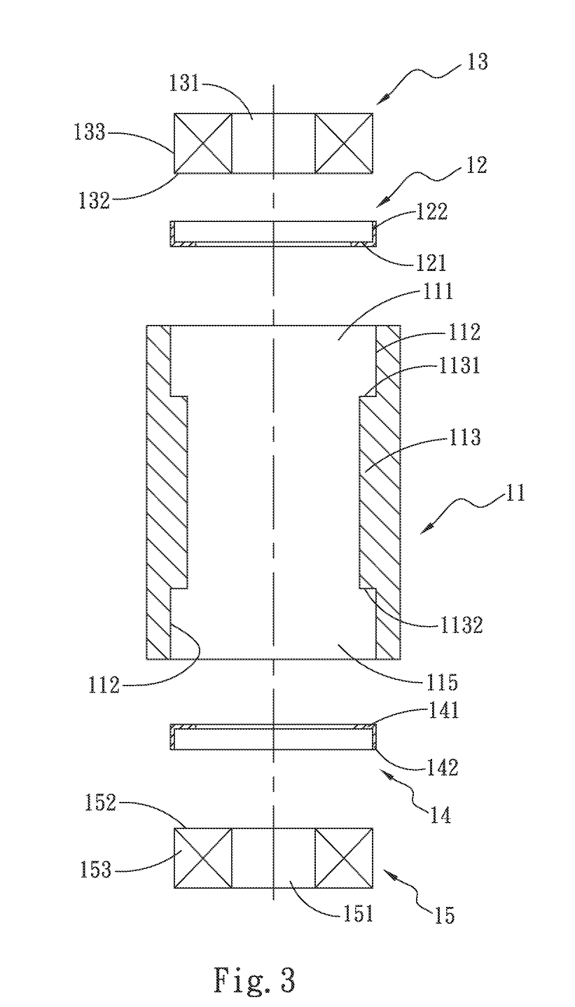

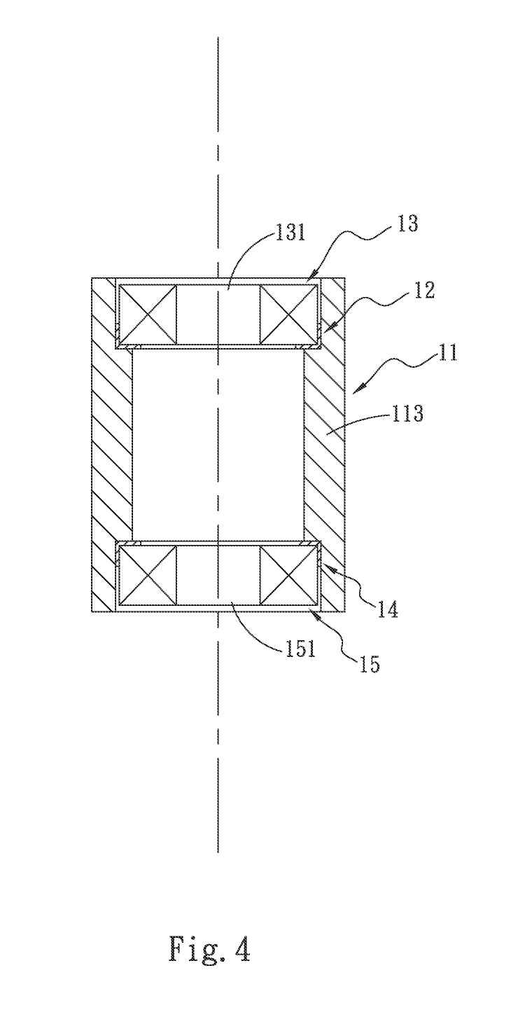

FIGS. 3 and 4 are exploded and assembled sectional views, respectively, of a bearing holding structure according to a second preferred embodiment of the present invention. As shown, the bearing holding structure in the second preferred embodiment has an overall configuration and element arrangements generally similar to those of the first preferred embodiment. Therefore, such similar configuration and arrangements in the second embodiment are not repeatedly discussed herein. The second preferred embodiment is different from the first preferred embodiment in that the other end of the hollow bearing cup 11 opposite to the first opening 111 is formed as a second opening 115 instead of a closed end, and that a second elastic member 14 and a second bearing 15 are further included and disposed in the second opening 115.

The second opening 115 is located at the other end of the hollow bearing cup 11 opposite to the first opening 111, and a second shoulder portion 1132 is formed between the radially inward protruded portion 113 and the inner wall surface 112 to face toward the second opening 115.

The second elastic member 14 includes a third section 141 and a fourth section 142 connected to each other at a right angle, so that the second elastic member 14 has a substantially L-shaped longitudinal cross section. The third section 141 of the second elastic member 14 tightly bears on the second shoulder portion 1132 and the fourth section 142 of the second elastic member 14 tightly bears on the inner wall surface 112 when the second elastic member 14 is disposed in the hollow bearing cup 11.

The second bearing 15 is disposed on the second elastic member 14 and includes a second shaft hole 151, a second bottom 152, and a second side wall 153. The second bottom 152 and the second side wall 153 tightly bear on the third section 141 and the fourth section 142 of the second elastic member 14, respectively. That is, the second elastic member 14 fills up a clearance between the second bearing 15 and the inner wall surface 112 and the second shoulder portion 1132, and provides a supporting and buffering effect on the second bearing 15 in both axial and radial directions to prevent the second bearing 15 in operation from colliding with the hollow bearing cup 11. With these arrangements, the bearing holding structure according to the second preferred embodiment of the present invention is structurally stable and the first and second bearings 13, 15 can operate stably in the hollow bearing cup 11.

In the illustrated second preferred embodiment, the axial direction indicates a direction to which the second bottom 152 of the second bearing 15 and the third section 141 of the second elastic member 14 are oriented; and the radial direction indicates a direction to which the second side wall 153 of the second bearing 15 and the fourth section 142 of the second elastic member 14 are oriented.

In the illustrated first and second preferred embodiments, the first and second bearings 13, 15 can be ball bearings, roller bearings, needle bearings, ceramic bearings, or oil-impregnated bearings; and the first and second elastic members 12, 14 can be silica-gel rings, rubber rings, or latex rings.

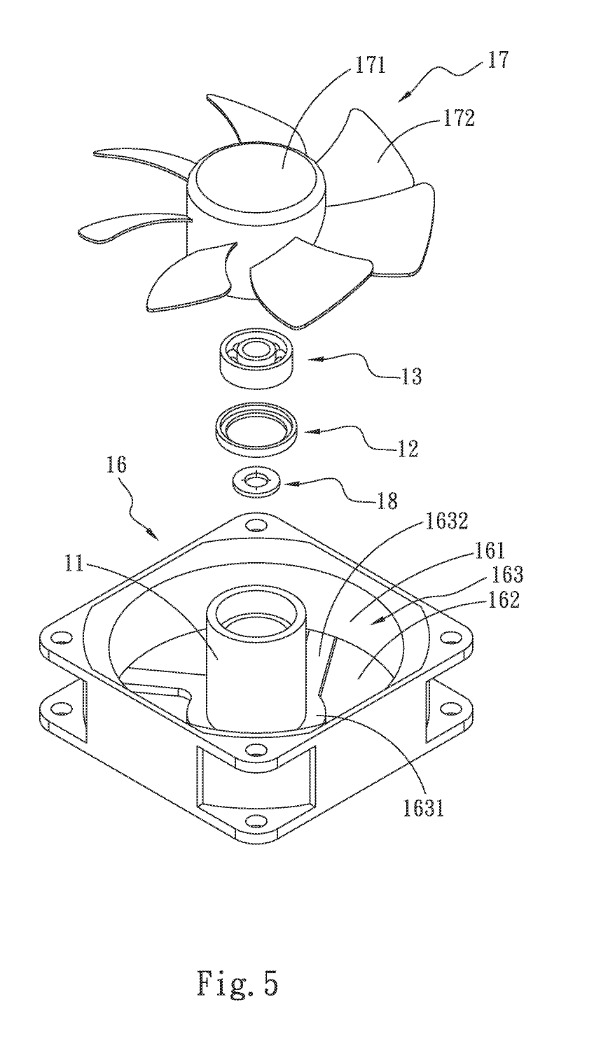

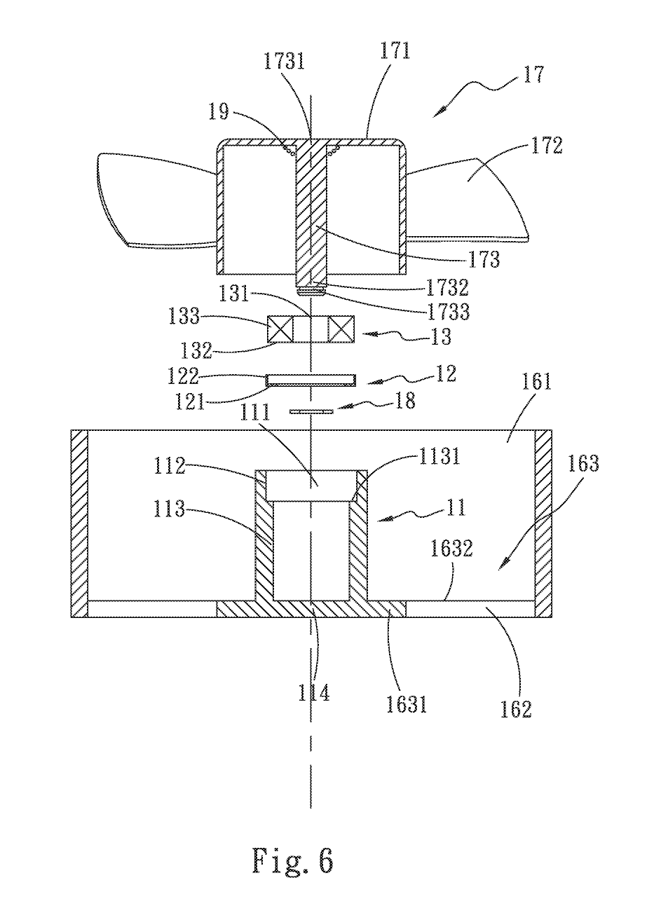

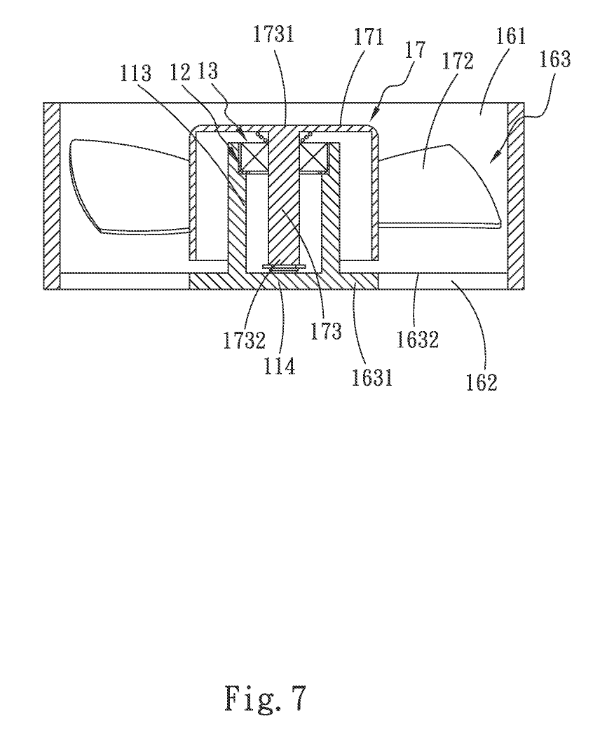

Please refer to FIGS. 5, 6 and 7 in which a fan module according to a third preferred embodiment of the present invention is shown. The fan module in the third preferred embodiment includes a frame 16, a fan wheel 17, a retaining ring 18, a spring 19, and a bearing holding structure according to the first preferred embodiment of the present invention. The bearing holding structure includes a hollow bearing cup 11, a first elastic member 12 and a first bearing 13, which along with the fan wheel 17, the retaining ring 18 and the spring 19 are located in the frame 16. Since the bearing holding structure according to the first preferred embodiment has been described above, it is not repeatedly discussed herein.

The frame 16 of the fan module in the third preferred embodiment has a first open end 161, a second open end 162 opposite to the first open end 161, an airflow passage 163 communicating the first open end 161 with the second open end 162, a base 1631, and a plurality of connecting arms 1632. The base 1631 and the connecting arms 1632 are located in the second open end 162, and the connecting arms 1632 are connected to between the base 1631 and a peripheral wall of the frame 16 to thereby locate the base 1631 at a center of the second open end 162. The hollow bearing cup 11 is formed on the base 1631 to axially project toward the first open end 161.

Please refer to FIGS. 5, 6 and 7 along with FIGS. 1 and 2. The hollow bearing cup 11 has the first elastic member 12 and the first bearing 13 received therein, as having been described in the first preferred embodiment of the present invention with reference to FIGS. 1 and 2.

The fan wheel 17 includes a hub 171, a plurality of blades 172, and a shaft 173. The blades 172 are spaced along an outer circumferential surface of the hub 171 to radially outward extend from the hub 171. The shaft 173 has a fixed end 1731 connected to an inner side of a top of the hub 171 and a free end 1732 extended through the first shaft hole 131 of the first bearing 13 into the hollow bearing cup 11, such that the first bearing 13 is tightly fitted around the shaft 173 and brings the shaft 173 to rotatably connect to the hollow bearing cup 11, allowing the whole fan wheel 17 to be rotatably mounted on the base 1631.

The free end 1732 of the shaft 173 is provided with an annular groove 1733, in which the retaining ring 18 is firmly fitted. The spring 19 is mounted around the shaft 173 to locate between the inner side of the hub 171 and the first bearing 13.

When the fan wheel 17 rotates, the shaft 173 and the first bearing 13 rotate along with the fan wheel 17. The first elastic member 12 disposed between the first bearing 13 and the first shoulder portion 1131 and the inner wall surface 112 of the hollow bearing cup 11 provides a supporting and buffering effect on the first bearing 13 in both axial and radial directions, preventing the first bearing 13 in operation from colliding with the inner wall surface 112 and the first shoulder portion 1131 of the hollow bearing cup 11. Therefore, the fan module according to the third preferred embodiment of the present invention can have solid structure and the first bearing 13 can operate stably in the hollow bearing cup 11 to reduce the noise produced during operation of the fan module.

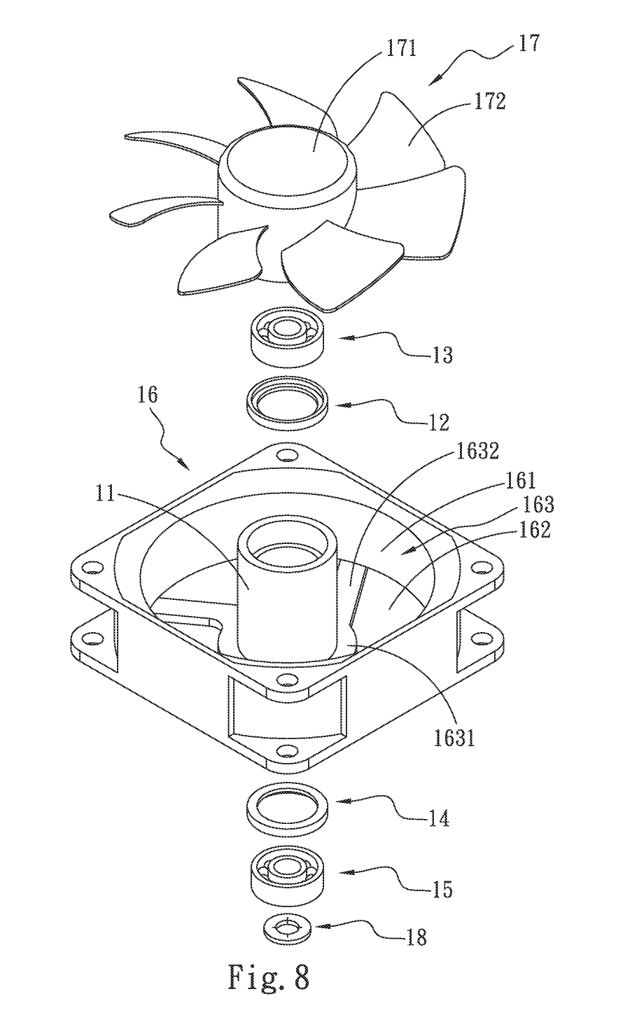

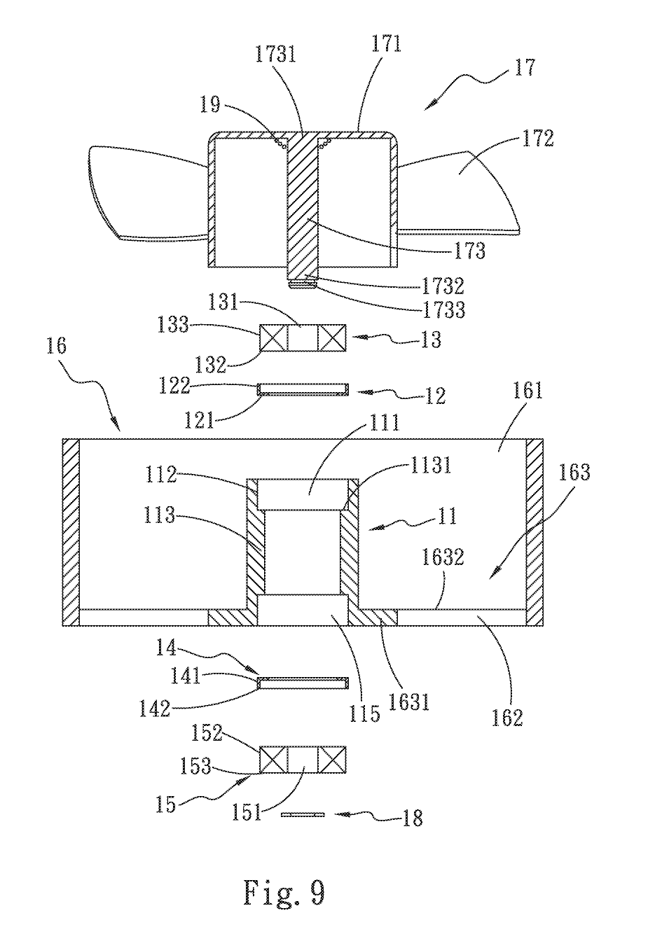

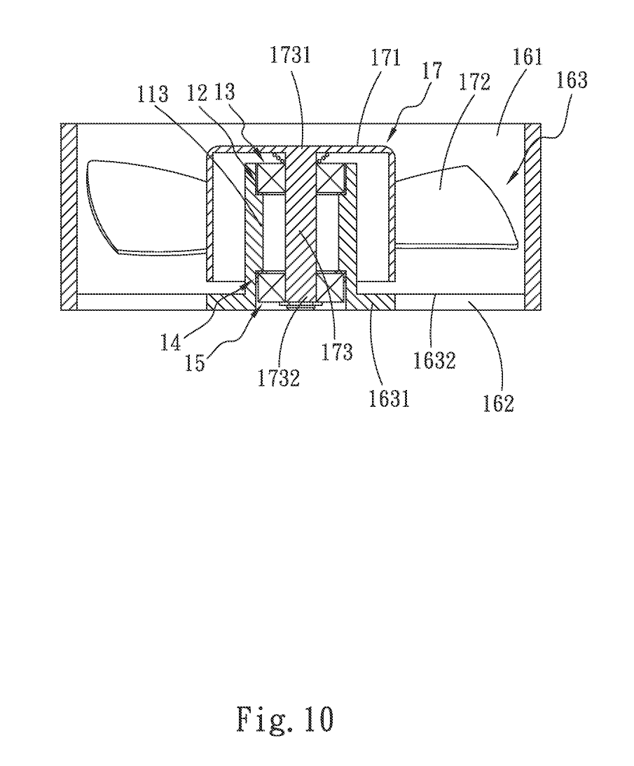

Please refer to FIGS. 8, 9 and 10 in which a fan module according to a fourth preferred embodiment of the present invention is shown. The fan module in the fourth preferred embodiment includes a frame 16, a fan wheel 17, a retaining ring 18, a spring 19, and a bearing holding structure according to the second preferred embodiment of the present invention. That is, the bearing holding structure includes a hollow bearing cup 11, a first elastic member 12 and a first bearing 13, and a second elastic member 14 and a second bearing 15, which along with the fan wheel 17, the retaining ring 18 and the spring 19 are located in the frame 16. Since the bearing holding structure according to the second preferred embodiment has been described with reference to FIGS. 3 and 4, it is not repeatedly discussed herein. Further, since the fan module in the fourth preferred embodiment is generally structurally similar to the third embodiment, elements and arrangements or operation thereof that are same in the third and the fourth embodiment are also not repeatedly discussed herein.

The second opening 115 of the hollow bearing cup 11 extends through the base 1631, and the free end 1732 of the shaft 173 first extends through the first shaft hole 131 of the first bearing 13 and then the second shaft hole 151 of the second bearing 15, such that the first bearing 13 and the second bearing 15 are tightly fitted around the shaft 173. The retaining ring 18 is fitted in the annular groove 1733 to locate between the free end 1732 of the shaft 173 and the second bearing 15 to support the second bearing 15 thereon. With these arrangements, the shaft 173 is located in and rotatably connected to the hollow bearing cup 11 via the first and second bearings 13, 15, bringing the whole fan wheel 17 to be rotatably mounted on the base 1631.

When the fan wheel 17 rotates, the shaft 173 and the first and the second bearing 13, 15 rotate along with the fan wheel 17. The first elastic member 12 disposed between the first bearing 13 and the first shoulder portion 1131 and the inner wall surface 112 of the hollow bearing cup 11 as well as the second elastic member 14 disposed between the second bearing 15 and the second shoulder portion 1132 and the inner wall surface 112 of the hollow bearing cup 11 provide a supporting and buffering effect on the first bearing 13 and the second bearing 15, respectively, in both axial and radial directions, preventing the first and the second bearing 13, 15 in operation from colliding with the first shoulder portion 1131 and the second shoulder portion 1132, respectively, and the inner wall surface 112 of the hollow bearing cup 11. Therefore, the fan module according to the fourth preferred embodiment of the present invention can have solid structure and the first and second bearings 13, 15 can operate stably in the hollow bearing cup 11 to reduce the noise produced during operation of the fan module.

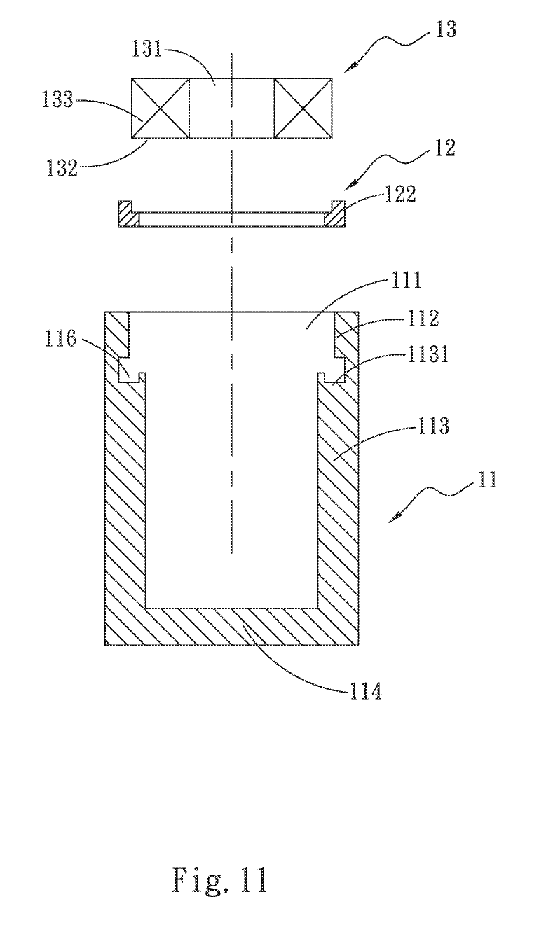

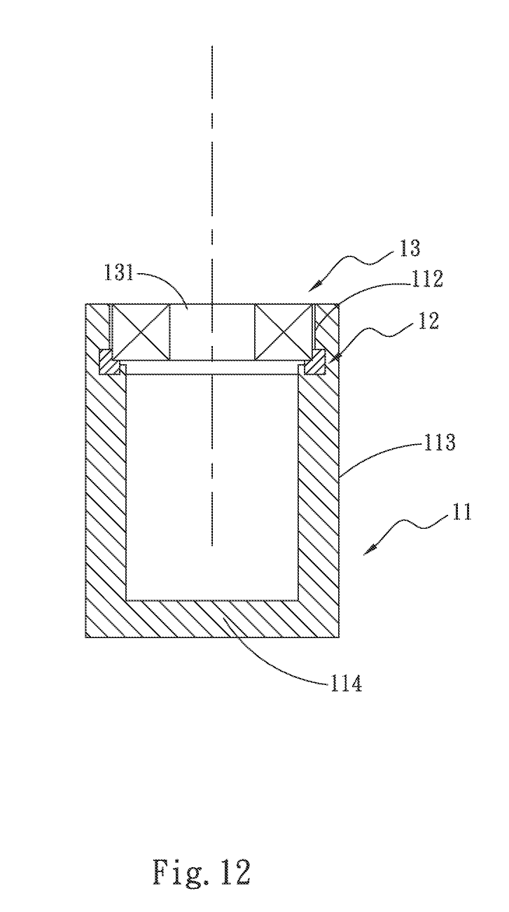

FIGS. 11 and 12 are exploded and assembled sectional views, respectively, of a bearing holding structure according to a fifth preferred embodiment of the present invention. The fifth embodiment is different from the first embodiment in that the hollow bearing cup 11 includes an annular channel 116, which is circumferentially formed along the inner wall surface 112 and has a lower portion downward extended into the first shoulder portion 1131, and that the first elastic member 12 is configured corresponding to the annular channel 116, so that one side of the first elastic member 12 facing toward the annular channel 116 is embedded and firmly set in the annular channel 116 without the risk of separating therefrom.

In conclusion, the present invention not only improves the problems existed in the prior art fan and the bearing thereof, but also provides the following advantages: (1) reducing the clearance between the hollow bearing cup 11 and the first and the second bearing 13, 15, so that the bearings 13, 15 are tightly fitted in the hollow bearing cup 11; (2) increasing the service life of the first and the second bearing 13, 15 while reducing noise produced by collision of the bearings 13, 15 with the hollow bearing cup 11; and (3) upgrading the stable operation of the first and the second bearings 13, 15.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A bearing holding structure, comprising:
a hollow bearing cup having a first opening and an inner wall surface; and a portion of the inner wall surface located behind the first opening by a predetermined distance being radially inward protruded toward a central axis of the hollow bearing cup, so that a first shoulder portion is formed between the inner wall surface and the radially inward protruded portion to face toward the first opening;
a first elastic member including a first section tightly bearing on the first shoulder portion and a second section tightly bearing on the inner wall surface of the hollow bearing cup; and the first and the second section being connected to each other; and
a first bearing being received in the hollow bearing cup and disposed on the first elastic member; and the first bearing including a first bottom tightly bearing on the first section of the first elastic member and a first side wall tightly bearing on the second section of the first elastic member.

2. The bearing holding structure as claimed in claim 1, wherein the hollow bearing cup has a closed end opposite to the first opening.

3. The bearing holding structure as claimed in claim 1, wherein the hollow bearing cup has a second opening opposite to the first opening.

4. The bearing holding structure as claimed in claim 3, further comprising a second shoulder portion formed between the inner wall surface and the radially inward protruded portion of the hollow bearing cup to face toward the second opening.

5. The bearing holding structure as claimed in claim 4, further comprising a second elastic member; and the second elastic member including a third section tightly bearing on the second shoulder portion and a fourth section tightly bearing on the inner wall surface of the hollow bearing cup.

6. The bearing holding structure as claimed in claim 5, further comprising a second bearing received in the hollow bearing cup and disposed on the second elastic member; and the second bearing including a second bottom tightly bearing on the third section of the second elastic member and a second side wall tightly bearing on the fourth section of the second elastic member.

7. The bearing holding structure as claimed in claim 1, wherein the first section and the second section of the first elastic member are connected to each other at a right angle, giving the first elastic member an L-shaped longitudinal section.

8. The bearing holding structure as claimed in claim 5, wherein the third section and the fourth section of the second elastic member are connected to each other at a right angle, giving the second elastic member an L-shaped longitudinal section.

9. The bearing holding structure as claimed in claim 6, wherein the third section and the fourth section of the second elastic member are connected to each other at a right angle, giving the second elastic member an L-shaped longitudinal section.

10. The bearing holding structure as claimed in claim 1, wherein the first bearing is selected from the group consisting of a ball bearing, a roller bearing, a needle bearing, a ceramic bearing, and an oil-impregnated bearing.

11. The bearing holding structure as claimed in claim 6, wherein the second bearing is selected from the group consisting of a ball bearing, a roller bearing, a needle bearing, a ceramic bearing, and an oil-impregnated bearing.

12. The bearing holding structure as claimed in claim 1, wherein the hollow bearing cup is internally provided with an annular channel, which is circumferentially extended along the inner wall surface and has a lower portion downward extended into the first shoulder portion; and the first elastic member being configured corresponding to the annular channel, so that one side of the first elastic member facing toward the annular channel is embedded in the annular channel.

13. The bearing holding structure as claimed in claim 1, wherein the first elastic member is selected from the group consisting of a silica-gel ring, a rubber ring, and a latex ring.

14. The bearing holding structure as claimed in claim 5, wherein the second elastic member is selected from the group consisting of a silica-gel ring, a rubber ring, and a latex ring.

15. A fan module, comprising:
a frame having a first open end, a second open end opposite to the first open end, an airflow passage communicating the first open end with the second open end, a base, and a plurality of connecting arms; the base and the connecting arms being located in the second open end, and the connecting arms being connected to between the base and a peripheral wall of the frame to thereby locate the base at a center of the second open end;
a hollow bearing cup being formed on the base and having a first opening and an inner wall surface; and a portion of the inner wall surface located behind the first opening by a predetermined distance being radially inward protruded toward a central axis of the hollow bearing cup, so that a first shoulder portion is formed between the inner wall surface and the radially inward protruded portion to face toward the first opening;
a first elastic member including a first section tightly bearing on the first shoulder portion and a second section tightly bearing on the inner wall surface of the hollow bearing cup; and the first and the second section being connected to each other;
a first bearing being received in the hollow bearing cup and disposed on the first elastic member; and the first bearing including a first bottom tightly bearing on the first section of the first elastic member and a first side wall tightly bearing on the second section of the first elastic member; and
a fan wheel being mounted on the base and including a hub, a plurality of blades, and a shaft; the blades being spaced along an outer circumferential surface of the hub to radially outward extend from the hub; and the shaft having a fixed end connected to the hub and a free end extended through the first bearing into the hollow bearing cup, so that the shaft is rotatably connected to the hollow bearing cup via the first bearing.

16. The fan module as claimed in claim 15, wherein the hollow bearing cup has a closed end opposite to the first opening.

17. The fan module as claimed in claim 15, wherein the hollow bearing cup has a second opening opposite to the first opening.

18. The fan module as claimed in claim 17, further comprising a second shoulder portion formed between the inner wall surface and the radially inward protruded portion of the hollow bearing cup to face toward the second opening.

19. The fan module as claimed in claim 18, further comprising a second elastic member; and the second elastic member including a third section tightly bearing on the second shoulder portion and a fourth section tightly bearing on the inner wall surface of the hollow bearing cup.

20. The fan module as claimed in claim 19, further comprising a second bearing received in the hollow bearing cup and disposed on the second elastic member;
and the second bearing including a second bottom tightly bearing on the third section of the second elastic member and a second side wall tightly bearing on the fourth section of the second elastic member.

21. The fan module as claimed in claim 15, wherein the first section and the second section of the first elastic member are connected to each other at a right angle, giving the first elastic member an L-shaped longitudinal section.

22. The fan module as claimed in claim 19, wherein the third section and the fourth section of the second elastic member are connected to each other at a right angle, giving the second elastic member an L-shaped longitudinal section.

23. The fan module as claimed in claim 20, wherein the third section and the fourth section of the second elastic member are connected to each other at a right angle, giving the second elastic member an L-shaped longitudinal section.

24. The fan module as claimed in claim 15, wherein the first bearing is selected from the group consisting of a ball bearing, a roller bearing, a needle bearing, a ceramic bearing, and an oil-impregnated bearing.

25. The fan module as claimed in claim 20, wherein the second bearing is selected from the group consisting of a ball bearing, a roller bearing, a needle bearing, a ceramic bearing, and an oil-impregnated bearing.

26. The fan module as claimed in claim 15, wherein the hollow bearing cup is internally provided with an annular channel, which is circumferentially extended along the inner wall surface and has a lower portion downward extended into the first shoulder portion; and the first elastic member being configured corresponding to the annular channel, so that one side of the first elastic member facing toward the annular channel is embedded in the annular channel.

27. The fan module as claimed in claim 15, wherein the first elastic member is selected from the group consisting of a silica-gel ring, a rubber ring, and a latex ring.

28. The fan module as claimed in claim 19, wherein the second elastic member is selected from the group consisting of a silica-gel ring, a rubber ring, and a latex ring.
